(19) United States
(12) Patent Application Publication
(10) Pub. No.: US 2006/0173939 A1
(43) Pub. Date: Aug. 3, 2006

(54) Garbage collection and compaction

(76) Inventors: Baolin Yin, Beijing (CN); Guei-Yuan Lueh, San Jose, CA (US); Gansha Wu, Beijing (CN); Xin Zhou, Beijing (CN)

Correspondence Address: KONRAD RAYNES & VICTOR, LLP, 315 S. BEVERLY DRIVE, # 210, BEVERLY HILLS, CA, 90212, US

(21) Appl. No.: 11/048,266

(22) Filed: Jan. 31, 2005

(51) Int. Cl. G06F 17/30

(52) U.S. Cl. 707/206

(57) ABSTRACT

Provided are a method, system, and article of manufacture, wherein a plurality of objects are allocated in dynamic memory. Reversed references are determined for the plurality of objects, wherein a reversed reference corresponding to an object is an address of a location that has a valid reference to the object. Unreferenced objects are deleted to fragment the dynamic memory. The fragmented dynamic memory is compacted via adjustments to the reversed references.

### BACKGROUND

Garbage collection is a memory management activity carried out by a system to reclaim dynamically allocated memory that is no longer being used. Garbage collection may be triggered in the system when free memory falls below a certain level, or after a certain number of memory allocations.

Garbage collection can relieve programmers from the burden of freeing allocated memory. For example, in certain programming languages, a heap may store objects created by an executing program. The objects created by the executing program may be allocated on the heap at run time. Garbage collection is the process of automatically freeing objects that are no longer referenced by the program. Periodic garbage collection frees the programmer from having to keep track of the need to free allocated memory.

When an object is no longer referenced by the program, the heap space occupied by the object may be recycled so that the heap space is available for new objects. A garbage collector may determine which objects are no longer referenced by the program and make available the heap space occupied by such unreferenced objects.

In addition to freeing unreferenced objects, a garbage collector may also reduce heap fragmentation that may occur during the course of program execution. If new objects are allocated, and unreferenced objects are freed, then free blocks of heap memory may be left in between blocks occupied by live objects. Requests to allocate new objects may have to be filled by extending the size of the heap even though there is enough total unused space in an existing fragmented heap. This may occur if there is not enough contiguous free heap space available into which the new object will fit. Therefore, a garbage collector may also compact the memory that is in use in the heap to reduce the working space needed for the heap.

### BRIEF DESCRIPTION OF THE DRAWINGS

Referring now to the drawings in which like reference numbers represent corresponding parts throughout:

FIG. 1 illustrates a computing environment, in accordance with certain embodiments;

FIG. 2 illustrates data structures implemented in the computing environment of FIG. 1, in accordance with certain embodiments;

FIG. 3 illustrates a directed graph that represents objects and references in a heap, in accordance with certain embodiments;

FIG. 4 illustrates an exemplary heap corresponding to the directed graph of FIG. 3, in accordance with certain embodiments;

FIG. 5a illustrates pseudo-code corresponding to a mark/scan based tracing process, in accordance with certain embodiments;

FIG. 5b illustrates pseudo-code corresponding to a compacting process, in accordance with certain embodiments;

FIG. 6 illustrates exemplary reverse reference records and an exemplary address mapping table corresponding to the exemplary heap of FIG. 4, in accordance with certain embodiments;

FIG. 7 illustrates a snapshot of the exemplary heap of FIG. 4 after a first exemplary object has been moved, in accordance with certain embodiments;

FIG. 8 illustrates a snapshot of the exemplary heap of FIG. 4 after a second exemplary object has been moved, in accordance with certain embodiments;

FIG. 9 illustrates a snapshot of an exemplary compacted heap, in accordance with certain embodiments;

FIG. 10 illustrates operations for garbage collection and compaction, in accordance with certain embodiments;

FIG. 11 illustrates a block diagram of a first system corresponding to certain elements of the computing environment of FIG. 1, in accordance with certain embodiments; and

FIG. 11 illustrates a block diagram of a second system including certain elements of the computing environment of FIG. 1, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Garbage collection may be a component of memory management in managed runtimes, such as, the Java* Runtime Environment (JRE) and the Common Language Runtime (CLR). The performance metrics for garbage collection on a computational device may include throughput and responsiveness. Throughput may depend on cumulative garbage collection pause time, while responsiveness may be determined by average and worst case pause times. Garbage collection may include a plurality of sequential or interleaving phases, such as, tracing, compacting, and sweeping, where the plurality of phases, may contribute to the pause time.
Java is a trademark or registered trademark of Sun Microsystems.

Certain embodiments, provide garbage collection and compaction for reducing the pause time of mark and sweep algorithms by using reversed references records and an address mapping table. In certain embodiments, the time complexity is proportional to the size of living objects instead of the total heap size. Certain embodiments trade space for compaction time, while at the same time controlling the amount of space overhead.

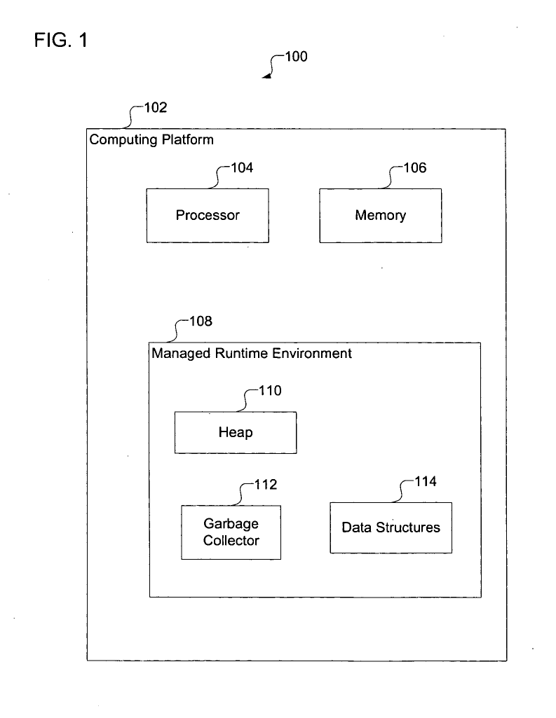

FIG. 1 illustrates a computing environment 100, in accordance with certain embodiments. The computing environment 100 comprises a computing platform 102 that includes at least one processor 104, a memory 106, and a managed runtime environment 108.

The computing platform 102 may comprise any suitable computational device including those presently known in the art, such as, a personal computer, a workstation, a server, a mainframe, a hand held computer, a palm top computer, a laptop computer, a telephony device, a network computer, a blade computer, etc. Code stored in a computer readable medium may be loaded into the memory 106 and be executed by the processor 104.

The managed runtime environment 108 may comprise a set of executables that allow a program to execute in the computing platform 102. In certain embodiments, the managed runtime environment 108 may include a JRE or a CLR. The managed runtime environment 108 may include a heap 110, a garbage collector 112 and associated data structures 114. The heap 110 comprises dynamic memory allocated by programs that execute in the computing platform 102. The garbage collector 112 frees unused memory from the heap 110 by using and updating information included in the data structures 114. The garbage collector 112 may also compact the heap 110 to reduce fragmentation of memory in the heap 110.

FIG. 1 illustrates certain embodiments in which the garbage collector 112 performs garbage collection and compaction in the managed runtime environment 108 by using data structures 114 that include reversed reference records.

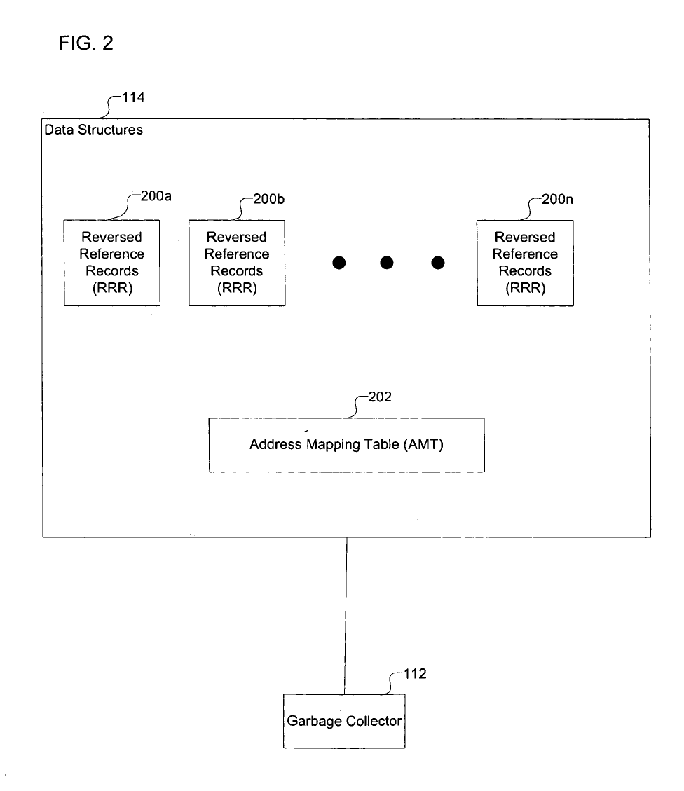

FIG. 2 illustrates data structures 114 implemented in the computing platform 102 of the computing environment 100, in accordance with certain embodiments.

The data structures 114 may include a plurality of reversed reference records (RRR) 200a, 200b, . . . , 200n and an address mapping table (AMT) 202. In certain embodiments, the RRRs 200a . . . 200n and the AMT 202 may be generated and updated by the garbage collector 112.

Reversed references of an object are the addresses of the locations containing legitimate, i.e., valid, references pointing to the object. An RRR, such as RRR 200a, corresponding to an object may store all references to the object.

In certain embodiments, when the RRRs 200a . . . 200n for survived objects, i.e., objects that are still being used and that cannot be freed, have been constructed by the garbage collector 112, the compacting phase of garbage collection starts and survived objects are compacted and pushed to one end of the heap 110. The contents of the RRRs 200a . . . 200n may be updated with new addresses after the heap 110 has been compacted. The efficiency of updating references in the RRRs 200a . . . 200n may depend on the AMT 202. The AMT 202 stores pairs of <old_address, new_address> mappings in such a manner, such that, given an old address, the new address can be recovered. Therefore the AMT 202 facilitates the process of recovering stale reversed references caused by the movement of objects in the heap 110. In the meantime, AMT maintains the old addresses of the living objects in a sorted manner so as to provide the objects without changing the order in which the living objects were allocated.

FIG. 2 illustrates certain embodiments in which the garbage collector 112 uses the RRRs 200a . . . 200n and the AMT 202 to perform garbage collection and compaction of the heap 110 of the managed runtime environment 108 in the computing platform 100.

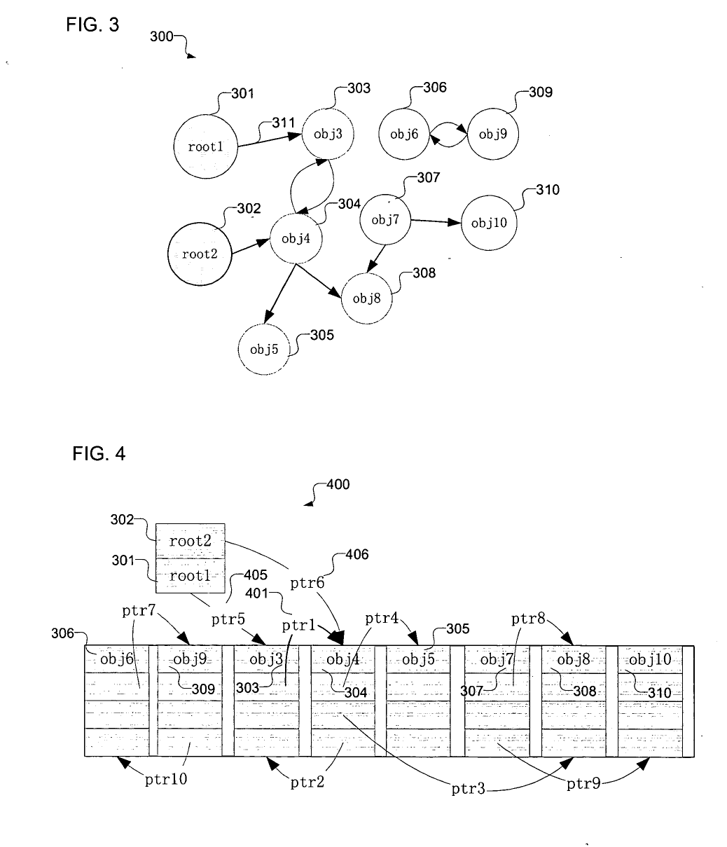

FIG. 3 illustrates an exemplary directed graph 300 that shows object relations in the heap 110.

A snapshot of the heap 110 can be represented by the notation (V, A), where V denotes a collection of nodes 303, 304, 305, 306, 307, 308, 309 residing in the heap 110 with roots 301, 302 (annotated by shading), and A denotes the collection of arcs that correspond to inter-object references or references from the roots 301, 302. The nodes 302, 303, 304, 305, 306, 307, 308, 309 and roots 301, 302 represent objects in the heap 110.

The exemplary directed graph 300 depicts a snapshot of the heap 110 before the garbage collector 112 reclaims dead objects, i.e. objects that are no longer in use. In the exemplary directed graph 300, root1 301 and root2 302 are roots of live objects discovered during root set enumeration, and nodes 303, 304, 305, 306, 307, 308, 309 represent heap objects. The arrowed arcs denote references. For example, the arrowed arc 311 indicates that root1 301 references the object obj3 303.

FIG. 4 illustrates an exemplary heap 400 corresponding to the directed graph 300 (of FIG. 3), in accordance with certain embodiments;

In the exemplary heap 400 the addresses increase from left to right. The exemplary heap 400 also shows the locations of the objects 303, 304, 305, 306, 307, 308, 309 of the directed graph 300. In the exemplary heap 400, the object with the lowest address is obj6 306 and the object with the highest address is obj10 310.

In certain embodiments, a tracing procedure for determining live nodes, i.e., nodes that are in use, starts from the roots 301, 302 and traverses through the references to all living objects reachable from the roots 301, 302. As can be seen from the directed graph 300 corresponding to the exemplary heap 400, the tracing procedure first reaches obj3 303 and obj4 304 from root1 301 and root2 302, and then reaches obj5 305 and obj8 308 via obj4 304. All other objects, namely obj6 306, obj7 307, obj9 309 and obj10 310, are never traced, and are garbage.

Therefore, FIG. 4. illustrates certain embodiments in which the garbage collector 112 determines which nodes are not reachable from root nodes. The nodes that cannot be reached from the root nodes are regarded as garbage, i.e., unused nodes, and can be deleted from the heap.

After objects have been deleted from a heap 110, the heap 110 may need to be compacted to remove fragmentation in the heap. In certain embodiments, the compaction task may be decomposed into four subtasks:
1. Collect bookkeeping information during the tracing procedure;
2. Calculate new positions for survived objects;
3. Move survived objects to the calculated new positions;
4. Update references of moved objects to the calculated new positions, to maintain the logical correctness of object relations.

Among the four subtasks, subtask 4 may dominate the total pause time. Certain compaction algorithms may perform one or more heap walks to deal with the reference updates. Certain embodiments may use semi-space and forwarding-addresses to trade size for time complexity in garbage compaction.

As shown earlier in FIG. 2, certain embodiments provide RRRs 200a . . . 200n and the AMT 202 to reduce the time complexity of reference updates at the expense of increased space overhead. Reversed references of an object are the addresses of the locations including legitimate references pointing to the object. For example, obj3 303 of FIG. 4 has a reference ptr1 401 pointing to obj4 304 of FIG. 4. Therefore, the address of ptr1 401 is a reversed reference of obj4 304. In certain embodiments, an RRR stores all references to a specific object. The notation RRR(obj4) may be used to indicate all of obj4's 304 reversed references. A more general form of RRR(obj) is as follows: RRR(obj)={RR1, RR2, . . . , RRn}, where *(RRi)=obj, i=1 . . . n. (The notation uses the ‘&’ operator on a reference to denote the reversed reference. Correspondingly, the ‘*’ operator is used to reference a reversed reference).

In the exemplary heap 400 of FIG. 4, RRR(obj4)={&ptr1, &ptr6/root2}. Here &ptr6 is annotated with a root tag which indicates that the address of ptr6 406 is never moved. In certain embodiments, when an object is moved to a new location, all references pointing to the object are updated using the RRRs 200a . . . 200n so as to avoid traversing the heap 110.

The construction of the RRRs 200a . . . 200n is based on the snapshot of the heap 110 before the compacting phase begins. The subsequent moving of survived objects may change the heap 110 and in turn invalidate the reversed references. For example, in FIG. 4, the reversed reference &ptr1 become outdated if obj3 303 is moved elsewhere. Hence, certain embodiments express the record as a tuple <obj_base, rr_offset> instead of the reversed reference itself. Obj_base denotes the base address of the object to which the reversed reference belongs, while rr_offset stands for the reversed reference's offset to the base address. Though obj_base may be changed with the moving of the object, rr_offset is an invariant. Certain embodiments can recover obsolete reversed reference by updating the base address with its new resident address. For example, the RRR for obj4 304 in FIG. 4 may represented using the tuple as:
RRR(obj4)={<obj3's address, &ptr1's offset>, &ptr6/root2}.

In certain embodiments, for the ease of tracking and recovering stale reversed reference, one extra word may be used for each reversed reference except for those from roots.

When all RRRs 200a . . . 200n for survived objects have been constructed, the compacting phase starts and survived objects are compacted and pushed to one end of the heap. The content of each RRR may be updated with the referred object's new address. The efficiency of updating references relies on the AMT 202. The AMT 202 stores pairs of <old_address, new_address> mappings in such a manner that, given an old address, certain embodiments can retrieve the new address efficiently. Therefore the AMT 202 facilitates the process of recovering stale reversed references caused by movements of objects. In the meantime, the AMT 202 maintains old addresses of the living objects in a sorted manner so as to provide the objects without changing the order in which the objects were allocated.

Certain embodiments, may perform garbage collection as follows:
1. Construct RRR and AMT (partially) during the tracing phase, and
2. Update RRR, maintain and query AMT during the compacting phase.

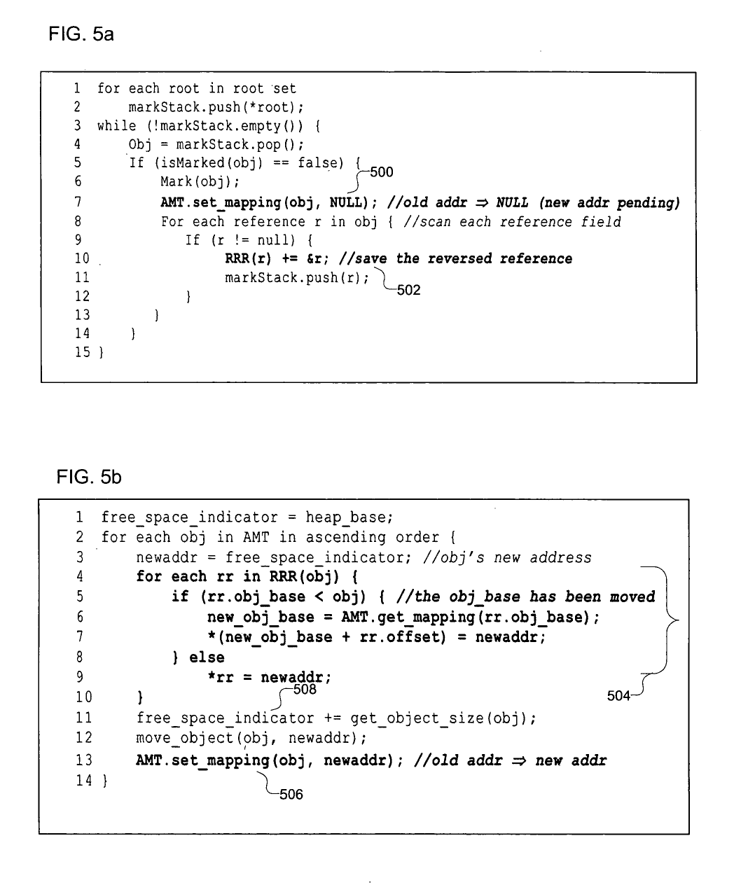

FIG. 5a illustrates pseudo-code corresponding to a mark/scan based tracing process, and FIG. 5b illustrates pseudo-code corresponding to a compacting process, in accordance with certain embodiments. The pseudo-code shown in FIGS. 5a, 5b may be implemented in the garbage collector 112. The AMT 202 is constructed (reference numeral 500) and the RRR's created (reference numeral 502). The AMT 202 is updated after space has been freed in the heap and objects moved (reference numerals 504, 506). The pseudo-code illustrated in FIGS. 5a, 5b will be described further with reference to subsequent figures.

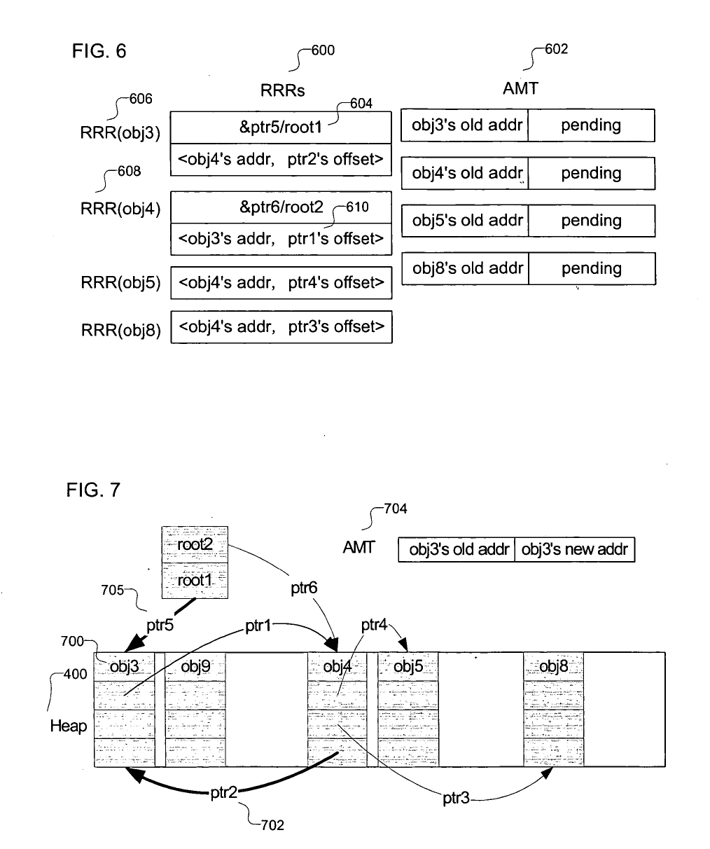

FIG. 6 illustrates exemplary reverse reference records 600 and an exemplary address mapping table 602 corresponding to the exemplary heap 400 of FIG. 4, in accordance with certain embodiments.

In certain embodiments corresponding to the exemplary heap 400 shown in FIG. 4, the mark/scan based tracking process starts from root1 301. Since root1 301 reaches obj3 303 via ptr5 405, the address of obj3 303 is inserted (reference numeral 502 of FIG. 5a) into AMT 602, and the reversed reference &ptr5/root1 604 is appended (reference numeral 502 of FIG. 5a) to RRR(obj3) 606. In FIG. 5a, at the end of an iteration obj3 303 is pushed onto the mark stack. In the next iteration, obj3 303 is popped off the mark stack. In the exemplary heap 400, obj3 303 has a reference ptr1 401 pointing to obj4 304. Similarly the address of obj4 304 is placed into AMT 202 and the reversed reference &ptr1 is added to RRR(obj4) 608 with the form of <obj3's address, ptr1's offset> 610. The process proceeds until the mark stack becomes empty. The resulting AMT 602 and RRRs 600 are shown in FIG. 6.

FIG. 7 illustrates a snapshot of the exemplary heap 400 of FIG. 4 after a first exemplary object obj3 303 has been moved in a compacting phase, in accordance with certain embodiments.

In the compacting stage shown in FIG. 7, since obj3 is the object with the smallest address in AMT 602, obj3 is moved to the beginning place (reference numeral 700) of the heap 400 (as indicated by free_space_indicator 508 in FIG. 5b). Then all the reversed references 606 of obj3 are visited and each of them are updated to the new address of obj3. After an object is moved to a new location, the mapping is updated (reference numeral 506 of FIG. 5b) in the AMT 704 for future query. FIG. 7 is the heap snapshot after obj3 is moved. The bold references ptr2 702 and ptr5 705 indicate that corresponding reversed references are updated.

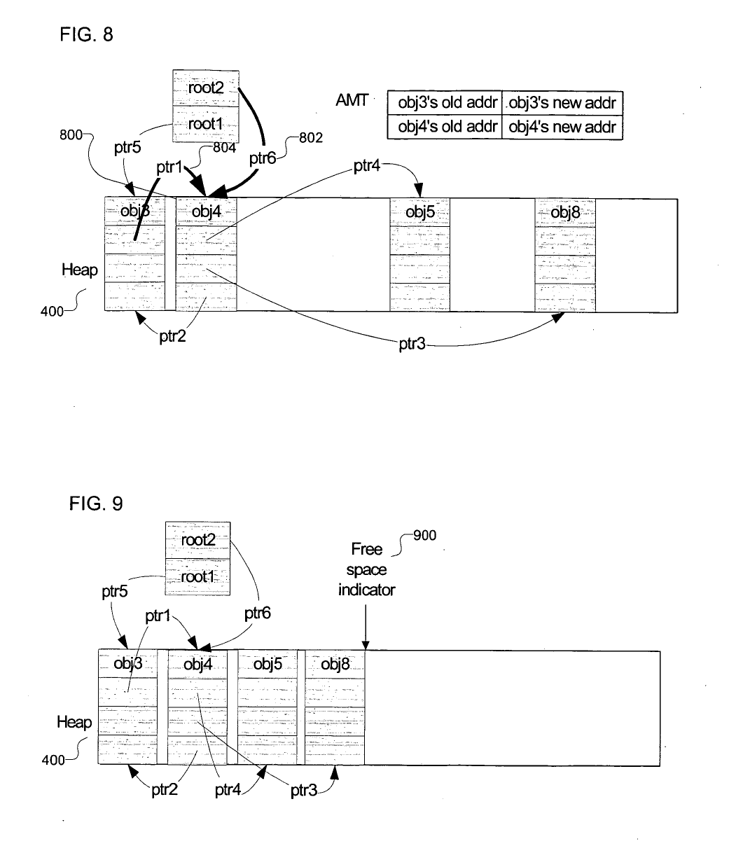

FIG. 8 illustrates a snapshot of an exemplary heap 400 of FIG. 4 after a second exemplary object obj4 304 has been moved, in accordance with certain embodiments.

After moving obj3, obj4 is the chosen candidate in the AMT. As soon as obj4 is moved to a new position (reference numeral 800), all the reversed references of obj4 are redirected to the new address. Note that the update of <obj3's addr, ptr1's offset> 610 is shown in FIG. 5b, Line 5-7 (encompassed by reference numeral 504) where the saved “obj3's addr” is smaller than “obj4's address”. Thus the AMT may be consulted to get the new position of obj3, and in turn augmented with “ptr1's offset” to recover the reversed reference. The bold references ptr6 802 and ptr1 804 indicate that corresponding reversed references are updated. After obj4 is moved, the snapshot of the heap 400 is shown in FIG. 8. The subsequent compaction of obj5 305 and obj8 308 works in a similar manner.

FIG. 9 illustrates a snapshot of an exemplary compacted heap 400, after obj3 303, obj4 304, obj5 305, and obj8 308 have been moved in the heap 400, in accordance with certain embodiments. The free space indicator 900 indicates the memory location in the heap 400 from which the heap is free. The next new object may be allocated from the address of the free space indicator 900.

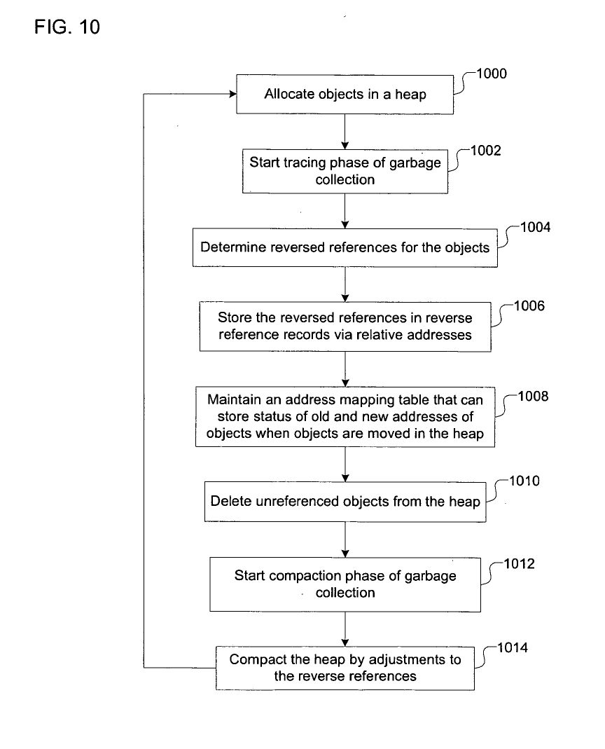

FIG. 10 illustrates operations for garbage collection and compaction, in accordance with certain embodiments. Certain operations may be implemented by the garbage collector 112.

Control starts at block 1000 where objects are allocated in a heap 110. The garbage collector 112 starts (at block 1002) the tracing phase of garbage collection in which the garbage collector 112 may initiate the process of marking and scanning of objects represented as nodes of a directed graph to delete unreferenced objects.

Control proceeds to block 1004, where the garbage collector 112 determines reversed references for the allocated objects. The garbage collector stores (at block 1006) the reversed references in reverse reference records 200a . . . 200n by using relative addresses for the reversed references.

The garbage collector 112 maintains (at block 1008) an address mapping table 202 that can store status of old and new addresses of objects when objects are moved from old to new addresses in the heap 110. The garbage collector 112 deletes (at block 1010) unreferenced objects from the heap 110, where unreferenced objects are objects that cannot be reached from roots, such as, roots 301, 302, and ends the tracing phase of garbage collection.

At the conclusion of block 1010, the heap 110 may be fragmented. The garbage collector 112 starts (at block 1012) the compaction phase of garbage collection. The garbage collector compacts (at block 1014) the heap 110 by adjustments to the reverse references. The compaction phase ends and control returns to block 1000, where new objects are allocated to the compacted heap.

Certain embodiments may spend processor time in maintaining and searching the AMT 202. In certain embodiments, the AMT 202 may be implemented as a sorted array, hash table, or tree-based data structures to reduce the processing time requirements. Certain embodiments that utilize hash table may provide a balance between performance and the complexity of the embodiment.

Certain embodiments maintain the allocation order of the survivor objects. Behavior of a cache and/or translation lookaside buffer (TLB) may be improved by maintaining the allocation order.

As far as space is concerned, certain embodiments need two additional spaces for the RRRs 200a . . . 200n and AMT 202 respectively. In certain embodiments the size of the AMT 202 is proportional to the number of living objects (number of nodes in a directed-graph model), while the space of RRR is proportional to the number of references (number of edges in a directed-graph model). The space of RRR may dominate the total space overhead in certain embodiments. Therefore, the space requirement of certain embodiments is controlled and in the worst cases, the embodiments can still deliver improved memory utilization.

In an exemplary worst case scenario, the heap 110 is completely filled with small objects that consist of a header and one reference field; all these objects survive the scavenging, and constitute a circular linked list, e.g., the reference field of each object points to the next object except that the reference field of the last object points to the first object. For a runtime system adopting certain copying garbage collectors, the object header is usually of 3 words to accommodate information such as virtual method dispatching, lock and forwarding address. For a heap of S words, there're totally N=S/(3+1) living objects. According to certain illustrated embodiments, AMT and RRR may budget 2*N and 2*N respectively, which is roughly the same size as the heap. At that point, only half of the consumed memory is available for living objects, which is the same as the semi-space copying garbage collection. From a quantitative point of view, garbage collection phase may introduce a burst space demand which leads to a space utilization no worse than 50%, which is favorable than the consistent utilization of 50% for the copying garbage collection. Moreover, certain embodiment have a mostly stable space utilization of 100% at the runtime.

Certain embodiments, theoretically demand higher space requirement than some conventional compaction algorithms. Nevertheless due to the low survival rate and reference density in practice, the extra space overhead is usually affordable for most runtime systems.

Certain embodiments provide a garbage collection and compaction algorithm where the time complexity proportional to the size of living objects instead of the total heap size. The space overhead is controlled in certain embodiments.

The described techniques may be implemented as a method, apparatus or article of manufacture involving software, firmware, micro-code, hardware and/or any combination thereof. The term “article of manufacture” as used herein refers to program instructions, code and/or logic implemented in circuitry [e.g., an integrated circuit chip, Programmable Gate Array (PGA), Application Specific Integrated Circuit (ASIC), etc.] and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed. Furthermore, program logic that includes code may be implemented in hardware, software, firmware or many combination thereof. The described operations associated with FIGS. 1-10 may be performed by circuitry, where “circuitry” refers to either hardware or software or a combination thereof. The circuitry for performing the operations of the described embodiments may comprise a hardware device, such as an integrated circuit chip, a PGA, an ASIC, etc. The circuitry may also comprise a processor component, such as an integrated circuit, and code in a computer readable medium, such as memory, wherein the code is executed by the processor to perform the operations of the described embodiments.

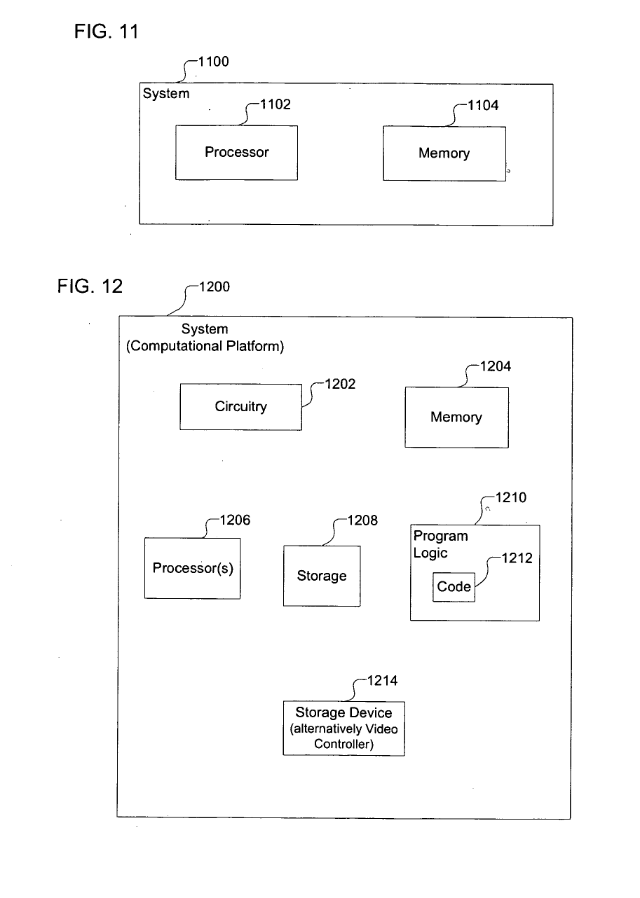

Certain embodiments illustrated in FIG. 11 may implement a first system 1100, wherein the first system 1100 comprises a processor 1102 coupled to a memory 1104, wherein the processor 1102 is operable to perform operations described in FIGS. 5a, 5b, and operations described in association with FIGS. 1-4, 6-9. The processor 1002 is capable of performing the operations performed by the garbage collector 112 of the computing platform 102.

FIG. 12 illustrates a block diagram of a second system 1200 in which certain embodiments may be implemented. Certain embodiments may be implemented in systems that do not require all the elements illustrated in the block diagram of the system 1200. The system 1200 may include circuitry 1202 coupled to a memory 1204, wherein the described operations associated with FIGS. 1-10 may be implemented by the circuitry 1202. In certain embodiments, the system 1200 may include one or more processors 1206 and a storage 1208, wherein the storage 1208 may be associated with program logic 1210 including code 1212, that may be loaded into the memory 1204 and executed by the processor 1206. In certain embodiments the program logic 1210 including code 1212 is implemented in the storage 1208. In certain other embodiments, the operations performed by program logic 1210 including code 1212 may be implemented in the circuitry 1202. Additionally, the system 1260 may also include a storage device 1214.

In certain embodiments, the storage device 1214 may be absent in the system 1200. Instead of the storage device 1214, in alternative embodiments the system 1200 may include another device, such as, a video controller or graphics controller device that renders information to display on a monitor coupled to the system 1200, where the system 1200 may comprise a desktop, workstation, server, mainframe, laptop, handheld computer, etc. An operating system may be capable of execution by the system, and the video controller may render graphics output via interactions with the operating system. Alternatively, some embodiments may be also be implemented in a computer system that does not include a video or graphics controller but includes a switch, router, etc.

At least certain of the operations associated with FIGS. 1-12 can be performed in parallel as well as sequentially. In alternative embodiments, certain of the operations may be performed in a different order, modified or removed. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-12 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
allocating a plurality of objects in dynamic memory;
determining reversed references for the plurality of objects, wherein a reversed reference corresponding to an object is an address of a location that has a valid reference to the object;
deleting unreferenced objects to fragment the dynamic memory; and
compacting the fragmented dynamic memory via adjustments to the reversed references.

2. The method of claim 1, further comprising:
storing the reversed references in a plurality of reverse reference records, wherein a reverse reference record for the object stores all reversed references corresponding to the object.

3. The method of claim 2, wherein the plurality of reverse reference records correspond to survived objects after the deleting of the unreferenced objects, wherein the reversed references are stored as offsets, wherein the offsets are relative addresses, and wherein the method further comprises:
updating the reverse reference records with new addresses subsequent to the compacting of the fragmented dynamic memory.

4. The method of claim 1, further comprising:
maintaining an address mapping table that stores status of old and new addresses of the plurality of objects, wherein a set of objects move from the old addresses to the new addresses in the dynamic memory, and wherein the new addresses can be retrieved from the old addresses for the set of objects.

5. The method of claim 1, further comprising:
constructing reverse reference records and an address mapping table during a tracing phase of garbage collection; and
updating and querying the address mapping table during a compacting phase of the garbage collection.

6. The method of claim 1, wherein an allocation order of the plurality of objects is maintained after a compaction of the dynamic memory.

7. The method of claim 1, wherein the allocating, the determining, the deleting, and the compacting are implemented as a component of a managed runtime environment, and wherein the dynamic memory is a heap in the managed runtime memory.

8. The method of claim 7, wherein the allocating, the determining, the deleting, and the compacting are performed during garbage collection in the managed runtime environment.

9. A system, comprising:
memory including dynamic memory; and
a processor coupled to the memory, wherein the processor is operable to:
(i) allocate a plurality of objects in the dynamic memory;
(ii) determine reversed references for the plurality of objects, wherein a reversed reference corresponding to an object is an address of a location that has a valid reference to the object;
(iii) delete unreferenced objects to fragment the dynamic memory; and
(iv) compact the fragmented dynamic memory via adjustments to the reversed references.

10. The system of claim 9, wherein the processor is further operable to:
store the reversed references in a plurality of reverse reference records, wherein a reverse reference record for the object stores all reversed references corresponding to the object.

11. The system of claim 10, wherein the plurality of reverse reference records correspond to survived objects after the unreferenced objects have been deleted, wherein the reversed references are stored as offsets, wherein the offsets are relative addresses, and wherein the processor is further operable to:
update the reverse reference records with new addresses subsequent to compacting of the fragmented dynamic memory.

12. The system of claim 9, wherein the processor is further operable to:
maintain an address mapping table that stores status of old and new addresses of the plurality of objects, wherein a set of objects move from the old addresses to the new addresses in the dynamic memory, and wherein the new addresses can be retrieved from the old addresses for the set of objects.

13. The system of claim 9, wherein the processor is further operable to:
construct reverse reference records and an address mapping table during a tracing phase of garbage collection; and
update and query the address mapping table during a compacting phase of the garbage collection.

14. The system of claim 9, wherein an allocation order of the plurality of objects is maintained after a compaction of the dynamic memory.

15. The system of claim 9, wherein allocating the plurality of objects in the dynamic memory, determining the reversed references, deleting the unreferenced objects, and compacting the fragmented dynamic memory are implemented as a component of a managed runtime environment, and wherein the dynamic memory is a heap in the managed runtime memory.

16. The system of claim 15, wherein the allocating of the plurality of objects in the dynamic memory, the determining of the reversed references, the deleting of the unreferenced objects, and the compacting of the fragmented dynamic memory are performed during garbage collection in the managed runtime environment.

17. A system, comprising:
memory including dynamic memory;
a video controller coupled to the memory; and
a processor coupled to the memory, wherein the processor is operable to:
(i) allocate a plurality of objects in the dynamic memory;
(ii) determine reversed references for the plurality of objects, wherein a reversed reference corresponding to an object is an address of a location that has a valid reference to the object;
(iii) delete unreferenced objects to fragment the dynamic memory; and
(iv) compact the fragmented dynamic memory via adjustments to the reversed references.

18. The system of claim 17, wherein the processor is further operable to:
store the reversed references in a plurality of reverse reference records, wherein a reverse reference record for the object stores all reversed references corresponding to the object.

19. The system of claim 17, wherein the processor is further operable to:
maintain an address mapping table that stores status of old and new addresses of the plurality of objects, wherein a set of objects move from the old addresses to the new addresses in the dynamic memory, and wherein the new addresses can be retrieved from the old addresses for the set of objects.

20. The system of claim 17, wherein the processor is further operable to:
construct reverse reference records and an address mapping table during a tracing phase of garbage collection; and
update and query the address mapping table during a compacting phase of the garbage collection.

21. An article of manufacture, wherein the article of manufacture comprises a machine accessible medium having stored therein instructions, and wherein the instructions when accessed cause a machine to:
allocate a plurality of objects in dynamic memory;
determine reversed references for the plurality of objects, wherein a reversed reference corresponding to an object is an address of a location that has a valid reference to the object;
delete unreferenced objects to fragment the dynamic memory; and
compact the fragmented dynamic memory via adjustments to the reversed reference

22. The article of manufacture of claim 21, wherein the instructions when accessed further cause the machine to:
store the reversed references in a plurality of reverse reference records, wherein a reverse reference record for the object stores all reversed references corresponding to the object.

23. The article of manufacture of claim 22, wherein the plurality of reverse reference records correspond to survived objects after the unreferenced objects have been deleted, wherein the reversed references are stored as offsets, wherein the offsets are relative addresses, and wherein the instructions when accessed further cause the machine to:
update the reverse reference records with new addresses subsequent to the compacting of the fragmented dynamic memory.

24. The article of manufacture of claim 21, instructions when accessed further cause the machine to:
maintain an address mapping table that stores status of old and new addresses of the plurality of objects, wherein a set of objects move from the old addresses to the new addresses in the dynamic memory, and wherein the new addresses can be retrieved from the old addresses for the set of objects.

25. The article of manufacture of claim 21, wherein the instructions when accessed further cause the machine to:
construct reverse reference records and an address mapping table during a tracing phase of garbage collection; and
update and query the address mapping table during a compacting phase of the garbage collection.

26. The article of manufacture of claim 21, wherein an allocation order of the plurality of objects is maintained after a compaction of the dynamic memory.

27. The article of manufacture of claim 21, wherein allocating the plurality of objects in the dynamic memory, determining the reversed references, deleting the unreferenced objects, and compacting the fragmented dynamic memory are implemented as a component of a managed runtime environment, and wherein the dynamic memory is a heap in the managed runtime memory.

28. The article of manufacture of claim 27, wherein the allocating of the plurality of objects in the dynamic memory, the determining of the reversed references, the deleting of the unreferenced objects, and the compacting of the fragmented dynamic memory are performed during garbage collection in the managed runtime environment.
